(19) United States
(12) Patent Application Publication
(10) Pub. No.: US 2026/0346604 A1
(43) Pub. Date: Nov. 5, 2026

(54) LIQUID EJECTION HEAD

(71) Applicant: CANON KABUSHIKI KAISHA, Tokyo (JP)

(72) Inventor: MASASHI ISHIKAWA, Tokyo (JP)

(21) Appl. No.: 19/665,353

(22) Filed: May 1, 2026

(30) Foreign Application Priority Data
May 1, 2025 (JP) 2025-076198

(51) Int. Cl. B41J 2/14; B41J 2/16; B41J 2/165

(52) U.S. Cl. CPC B41J 2/14024; B41J 2/14072; B41J 2/1433; B41J 2/1601; B41J 2/1623; B41J 2/16502; B41J 2/16535; B41J 2002/14362; B41J 2002/14491

(57) ABSTRACT

A liquid ejection head including: a plurality of liquid ejection devices aligned in a first direction and configured to eject liquid; a common channel member bonded to the plurality of liquid ejection devices; and a sealing resin provided in a gap in the first direction between a first liquid ejection device and a second liquid ejection device that are the liquid ejection devices adjacent to each other among the plurality of liquid ejection devices. Part of the first liquid ejection device overlaps the second liquid ejection device as viewed in a second direction perpendicular to a plane of the common channel member to which the plurality of liquid ejection devices are bonded.

### BACKGROUND

### Field of the Technology

The present disclosure relates to a liquid ejection head.

### Description of the Related Art

A liquid ejection apparatus such as an inkjet printer includes a liquid ejection head configured to eject liquid such as inks and a cleaning mechanism configured to remove ink mist, paper dust, or the like attached to the liquid ejection head. The liquid ejection head includes, for example, multiple liquid ejection chips having ejection port surfaces on which multiple ejection ports are formed. The cleaning mechanism regularly cleans the ejection port surfaces of the liquid ejection chips by using a tube with a suction function, a wiper that is an elastic body, and the like. In the case where large steps are present around the liquid ejection chips, a suction pressure of the cleaning mechanism cannot be increased, or the wiper that is the elastic body cannot follow the steps around the liquid ejection chips. Accordingly, unwiped ink mist, paper dust, or the like is generated on the ejection port surfaces of the liquid ejection chips. The unwiped ink mist, the paper dust, or the like on the ejection port surfaces of the liquid ejection chips may fall on a paper surface subjected to printing, and reduce print quality.

For example, Japanese Patent Laid-Open No. 2024-049554 (Literature 1) proposes a technique of reducing steps around liquid ejection chips by filling gaps between a member around the liquid ejection chips and the liquid ejection chips with a sealing resin. In the technique disclosed in Literature 1, an uncured sealing resin with low viscosity is applied around the liquid ejection chips. Moreover, the liquid ejection chips are electrically connected to electric wiring substrates to form liquid ejection devices. The uncured sealing resin applied around the liquid ejection chips fill gaps between the adjacent liquid ejection devices among the multiple liquid ejection devices (liquid ejection chips).

In the liquid ejection head including multiple liquid ejection devices (liquid ejection chips), air bubbles tend to be trapped in the sealing resin filling the gaps between adjacent liquid ejection devices. In the case where the air bubbles trapped in the gaps between the adjacent liquid ejection devices burst, the sealing resin scatters and attaches to the ejection port surfaces of the liquid ejection devices in some cases, and the print quality may decrease.

### SUMMARY

An object of the present disclosure is to provide a liquid ejection head capable of stabilizing print quality.

A liquid ejection head according to one aspect of the present disclosure includes: a plurality of liquid ejection devices aligned in a first direction and configured to eject liquid; a common channel member bonded to the plurality of liquid ejection devices; and a sealing resin provided in a gap in the first direction between a first liquid ejection device and a second liquid ejection device that are the liquid ejection devices adjacent to each other among the plurality of liquid ejection devices. Part of the first liquid ejection device overlaps the second liquid ejection device as viewed in a second direction perpendicular to a plane of the common channel member to which the plurality of liquid ejection devices are bonded.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective diagram illustrating part of a liquid ejection apparatus;

FIG. 2 is a perspective diagram illustrating an example of a cleaning mechanism;

FIG. 3 is a perspective diagram of a liquid ejection head;

FIGS. 4A and 4B are schematic diagrams illustrating a liquid ejection device of a first embodiment;

FIG. 5 is a flowchart illustrating part of a manufacturing process of the liquid ejection head;

FIG. 6 is a schematic diagram for explaining a process of bonding the liquid ejection devices to a common channel member;

FIGS. 7A and 7B are schematic diagrams for explaining the process of bonding the liquid ejection devices to the common channel member;

FIG. 8 is a schematic diagram for explaining a process of bending electric wiring substrates of the liquid ejection devices;

FIG. 9 is a schematic diagram for explaining a process of bonding a frame member to the common channel member;

FIG. 10 is a schematic diagram for explaining a process of applying a sealing resin;

FIGS. 11A and 11B are schematic diagrams for explaining the process of applying the sealing resin;

FIGS. 12A and 12B are schematic diagrams for explaining air bubbles trapped in a gap between the adjacent liquid ejection devices;

FIGS. 13A and 13B are schematic diagrams illustrating the liquid ejection device of a second embodiment;

FIG. 14 is a schematic diagram for explaining a process of applying the sealing resin;

FIGS. 15A and 15B are schematic diagrams for explaining a process of applying the sealing resin;

FIGS. 16A and 16B are schematic diagrams for explaining air bubbles trapped in the gap between the adjacent liquid ejection devices;

FIGS. 17A and 17B are schematic diagrams illustrating the liquid ejection device of a third embodiment; and

FIGS. 18A and 18B are schematic diagrams for explaining air bubbles trapped in the gap between the adjacent liquid ejection devices.

### DESCRIPTION OF THE EMBODIMENTS

Preferable embodiments of the present disclosure are explained below in detail with reference to the attached drawings. Note that the following embodiments do not limit matters of the present disclosure, and not all of combinations of characters explained in the following embodiments are necessarily essential for solving means of the present disclosure. Note that the same configurations are explained by being denoted by the same signs.

### First Embodiment

### Configuration of Liquid Ejection Apparatus

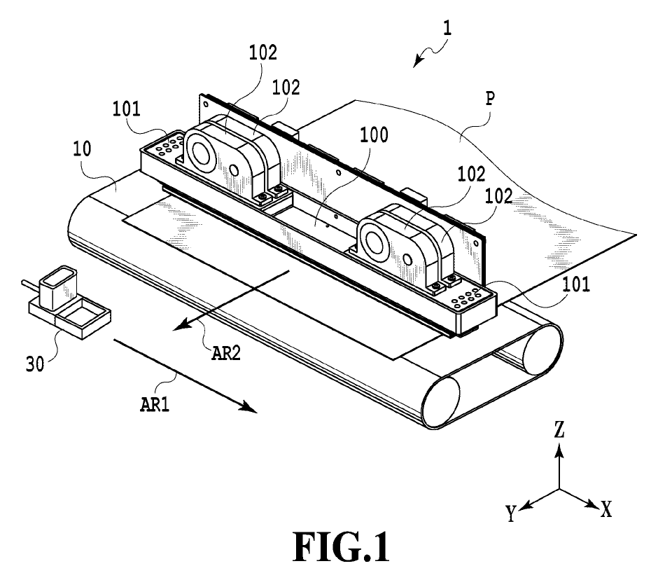

FIG. 1 is a perspective diagram illustrating part of a liquid ejection apparatus 1 using a liquid ejection head 100 according to the present embodiment. As illustrated in FIG. 1, the liquid ejection apparatus 1 includes a conveyance unit 10, the liquid ejection head 100, a cleaning mechanism 30, and a control board (not illustrated). Note that, in FIGS. 1-4A, 6-11A, 13-15A, and 17A, a Z direction illustrates the vertical direction, and intersects (is orthogonal to in the present embodiment) an X-Y plane defined by an X direction and a Y direction.

The conveyance unit 10 conveys a print medium P in a conveyance direction (for example, +Y direction). For example, a cut paper, a roll paper, a film, or the like is used as the print medium P. The liquid ejection head 100 prints an image on the print medium P by ejecting liquid (for example, inks) to the print medium P. The liquid ejection head 100 is a so-called line-type liquid ejection head in which ejection ports are aligned to correspond to the width (for example, length in the X direction) of the print medium P. The liquid ejection head 100 may be a liquid ejection head for monochrome printing that ejects one type of ink (for example, black ink). The liquid ejection head 100 may be a liquid ejection head for full-color printing that ejects multiple types of inks (for example, four types of inks of cyan ink, magenta ink, yellow ink, and black ink).

Moreover, the liquid ejection head 100 is electrically connected to a wiring substrates (not illustrated) that transmit electric power and ejection control signals. The inks stored in main tanks (not illustrated) are supplied to the liquid ejection head 100 via liquid supply tubes, buffer tanks (not illustrated), and the like forming supply channels of the inks. Liquid connecting portions 101 are provided in both end portions of the liquid ejection head 100. The liquid connecting portions 101 connect the supply channels of the inks provided in an apparatus main body to liquid channels provided in the liquid ejection head 100. The inks are thereby supplied from the supply channels in the apparatus main body to the liquid ejection head 100, and the inks that have passed the liquid channels in the liquid ejection head 100 are collected into the supply channels in the apparatus main body. As described above, the inks are circulated by passing through the supply channels of the apparatus main body and the liquid channels of the liquid ejection head 100. Note that supply pressures of the inks supplied to the liquid ejection head 100 are adjusted by pressure adjustment mechanisms 102 provided in the liquid ejection head 100.

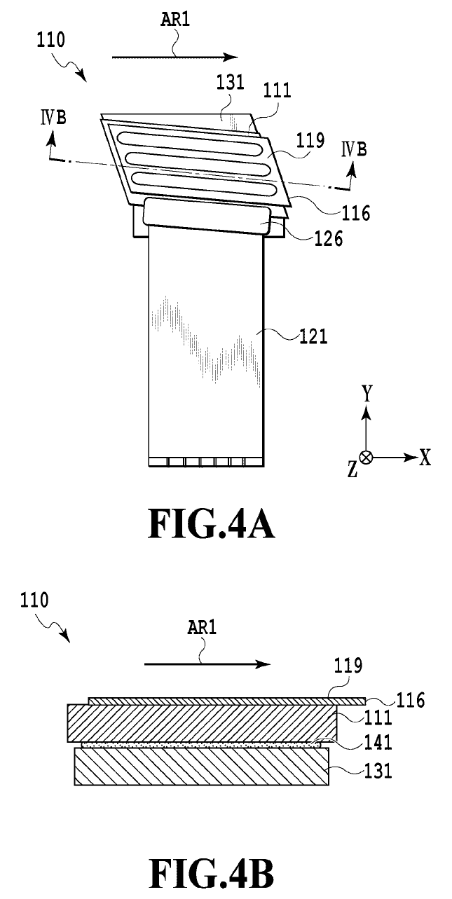

The cleaning mechanism 30 cleans an ejection port surface (face surface) on which the ejection ports of the inks are formed in the liquid ejection head 100 in a state where the liquid ejection head 100 is moved to a cleaning position. Note that the cleaning position is located downstream (for example, +Y direction side) of the conveyance unit 10 in the conveyance direction. The first arrow AR1 in FIGS. 1, 4A, and 4B illustrates a direction in which the cleaning mechanism 30 moves in cleaning. The second arrow AR2 in FIG. 1 illustrates a direction in which the liquid ejection head 100 moves from a print position (see FIG. 1) where printing is performed to the cleaning position.

The control board (not illustrated) controls the conveyance unit 10, the liquid ejection head 100, the cleaning mechanism 30, and the like. The liquid ejection apparatus 1 performs printing on the print medium P in one pass by controlling operations of the conveyance unit 10, the liquid ejection head 100, and the like with the control board. Moreover, the liquid ejection apparatus 1 can continuously perform printing while conveying multiple print media P by controlling operations of the conveyance unit 10, the liquid ejection head 100, and the like with the control board.

### Configuration of Cleaning Mechanism

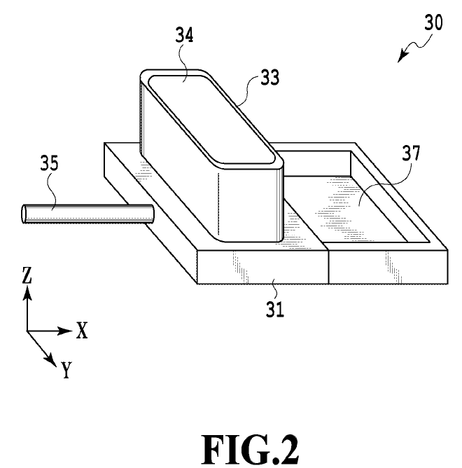

FIG. 2 is a perspective diagram illustrating an example of the cleaning mechanism 30. As illustrated in FIG. 2, the cleaning mechanism 30 includes a base portion 31, a wiper 33, a suction tube 35, and a receiving portion 37. The base portion 31 can be moved in one direction (for example, +X direction) by a moving mechanism (not illustrated). The wiper 33 is provided in an upper portion of the base portion 31. The wiper 33 is formed in a square tube shape extending upward (in +Z direction) from the base portion 31. Moreover, the wiper 33 is formed by using a material with high elasticity such as rubber or elastomer. The suction tube 35 communicates with an internal space 34 of the wiper 33 via the base portion 31. A suction pump (not illustrated) is connected to the suction tube 35. The receiving portion 37 is formed adjacent to and on the +X direction side of the base portion 31. The receiving portion 37 can receive ink mist, paper dust, or the like falling from the liquid ejection head 100.

In a state where the liquid ejection head 100 is moved to the cleaning position, a rim portion of the wiper 33 comes into contact with the ejection port surface (face surface) of the liquid ejection head 100, and the base portion 31 is moved in one direction by an operation of the moving mechanism (not illustrated). Ink mist, paper dust, or the like attached to the surface on which the ejection ports of the inks are formed in the liquid ejection head 100 are sucked into the internal space 34 of the wiper 33 by an operation of the suction pump, or are wiped off by the rim portion of the wiper 33. The cleaning mechanism 30 thereby removes the ink mist, the paper dust, or the like attached to the surface on which the ejection ports of the inks are formed in the liquid ejection head 100.

### Configuration of Liquid Ejection Head

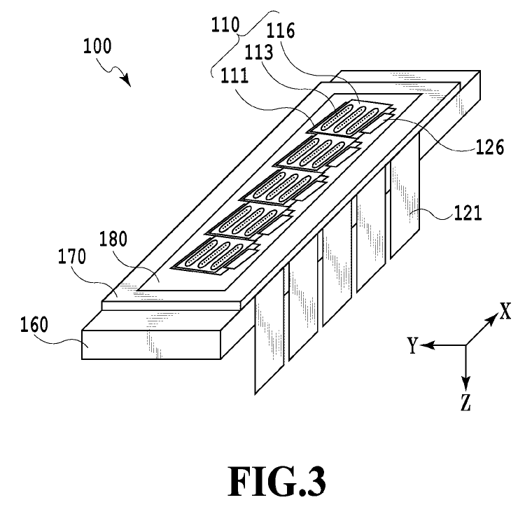

Next, the liquid ejection head 100 is explained. FIG. 3 is a perspective diagram of the liquid ejection head 100 according to the first embodiment. In the present embodiment, a configuration capable of stabilizing print quality is explained.

As illustrated in FIG. 3, the liquid ejection head 100 according to the first embodiment includes multiple liquid ejection devices 110, a common channel member 160, a frame member 170, and a sealing resin 180. The common channel member 160 is formed in a rectangular plate shape extending in the X direction. The common channel member 160 is bonded to five liquid ejection devices 110 arranged side by side in a fixed direction (X direction that is a first direction). The frame member 170 is formed in a rectangular frame shape extending in the X direction. The frame member 170 is bonded to a portion near an outer periphery of the common channel member 160, and surrounds peripheries of the five liquid ejection devices 110 (liquid ejection chips 111). The sealing resin 180 is applied to the common channel member 160, and fills the peripheries of the five liquid ejection devices 110 (liquid ejection chips 111) surrounded by the frame member 170. Moreover, the sealing resin 180 fills a gap between each adjacent two of the five liquid ejection devices 110. A thermosetting resin or a room temperature curing resin is used as the sealing resin 180 depending on necessary mechanical properties. For example, a two-component room temperature curing adhesive agent with low elasticity is used as the sealing resin 180. This can reduce stress generated in the liquid ejection chips 111 in the case where the temperature of the liquid ejection head 100 changes.

FIGS. 4A and 4B are schematic diagrams illustrating the liquid ejection device 110 of the first embodiment. FIG. 4A is a plan diagram of the liquid ejection device 110. FIG. 4B is a cross-sectional diagram along IVB-IVB in FIG. 4A. As illustrated in FIGS. 4A and 4B, each of the liquid ejection devices 110 of the first embodiment includes the liquid ejection chip 111, a protection member 116, an electric wiring substrate 121, and a support member 131.

The liquid ejection chip 111 is formed in a parallelogram plate shape extending along a direction in which the multiple liquid ejection devices 110 are arranged side by side (+X direction). As descried above, the planar shape of the liquid ejection chip 111 is a parallelogram. The liquid ejection chip 111 includes multiple ejection ports 113 (see FIG. 3) configured to eject the ink (liquid). The multiple ejection ports 113 are aligned along an extending direction of the liquid ejection chip 111. In other words, the liquid ejection chip 111 extends along a direction in which the ejection ports 113 are aligned. Electric connection terminals (not illustrated) are provided in one lateral end portion of the liquid ejection chip 111. The electric connection terminals of the liquid ejection chip 111 are connected to electric connection terminals (not illustrated) provided in one end portion of the electric wiring substrate 121.

Moreover, the liquid ejection chip 111 includes a silicon substrate (not illustrated) with a thickness of about 0.6 mm to 1 mm, multiple electrothermal transducing elements (not illustrated), and electric wiring (not illustrated). The multiple ejection ports are formed in the silicon substrate of the liquid ejection chip 111. A surface of the silicon substrate on which the ejection ports are formed is also referred to as "front surface" hereinafter. The multiple electrothermal transducing elements of the liquid ejection chip 111 are arranged in portions of the silicon substrate facing the multiple ejection ports. The electric wiring of the liquid ejection chip 111 is electrically connected to each of the electrothermal transducing elements. The electrothermal transducing elements convert electric power supplied via the electric wiring to thermal energy. The electrothermal transducing elements eject the liquid such as the ink from the ejection ports by applying the converted thermal energy to the liquid. The electric wiring of the liquid ejection chip 111 is formed in the silicon substrate by using, for example, a film formation technique. The electric connection terminals connected to the electric wiring are arranged side by side in the X direction in the one lateral end portion on a front surface of the liquid ejection chip 111. The multiple electric connection terminals arranged side by side in the X direction form a terminal array. The electric connection terminals of the liquid ejection chip 111 are plated by gold in consideration of a flatness of the electric connection terminal, an electric resistance in transmission of the electric signal, and the like. The electric connection terminals of the liquid ejection chip 111 and the electric connection terminals of the electric wiring substrate 121 are wire-bonded to one another to achieve electric connection between the liquid ejection chip 111 and the electric wiring substrate 121.

Moreover, the liquid ejection chip 111 includes multiple liquid channels (not illustrated) communicating with the multiple ejection ports and a liquid supply passage (not illustrated) for supplying the liquid to the multiple liquid channels, in addition to the multiple ejection ports. The liquid supply passage of the liquid ejection chip 111 is formed of a hole penetrating the silicon substrate from the front surface of the silicon substrate to a back surface (surface on the opposite side to the front surface of the silicon substrate) of the silicon substrate. The multiple ejection ports and the multiple liquid channels are formed on the front surface side of the silicon substrate by a photolithography technique.

The electric wiring substrate 121 is formed by using a flexible substrate with a thickness of 0.1 mm to 0.3 mm, and is formed in a film shape by a certain processing method, for example, machining such as punching or a chemical processing method such as etching. Note that the thickness of the flexible substrate is not limited to 0.1 mm to 0.3 mm. The one end portion of the electric wiring substrate 121 is electrically connected to the liquid ejection chip 111 via the electric connection terminals (not illustrated). The other end portion of the electric wiring substrate 121 is electrically connected to the control board (not illustrated) for controlling the liquid ejection head 100. A connecting portion (electric connection terminals) between the electric wiring substrate 121 and the liquid ejection chip 111 is insulated and protected by a sealing material 126. The liquid ejection chip 111 electrically connected to the electric wiring substrate 121 is bonded to the support member 131 by using a chip adhesive agent 141 (see FIG. 4B).

The support member 131 is formed in a rectangular plate shape extending along the direction in which the multiple liquid ejection devices 110 are arranged side by side (+X direction). The support member 131 supports the liquid ejection chip 111 and the electric wiring substrate 121, and is bonded to the common channel member 160. Moreover, the support member 131 has a function of a channel for supplying the ink in the common channel member 160 to the liquid ejection chip 111. The support member 131 is bonded to the liquid ejection chip 111 electrically connected to the electric wiring substrate 121, by using the chip adhesive agent 141 that is, for example, a thermosetting adhesive agent. The shape and the material of the support member 131 are not limited as long as the support member 131 has a region capable of supporting the liquid ejection chip 111 and the electric wiring substrate 121. For example, a resin, a ceramic, a metal, or the like can be given as the material of the support member 131. Note that, in the case where the chip adhesive agent 141 is the thermosetting adhesive agent, the support member 131 is preferably formed by using a plate made of alumina with high heat resistance.

The protection member 116 is formed in a parallelogram plate shape similar to the liquid ejection chip 111 by using a metal plate, a silicon substrate, or the like. In the case where the metal plate is used, the protection member 116 is formed by machining such as punching. In the case where the silicon substrate is used, the protection member 116 is formed by a chemical processing method such as etching. The protection member 116 is stacked on and bonded to the front surface of the liquid ejection chip 111 by using, for example, adhesive agent or the like at an interval large enough to cancel out a tolerance in a thickness direction of the protection member 116. Openings with an elongated hole shape corresponding to three ejection port arrays in which the multiple ejection ports 113 are aligned are formed in the protection member 116. A face surface 119 having the openings through which the three ejection port arrays (ejection ports 113) are exposed is formed on a front surface of the protection member 116. The protection member 116 covers and protects the front surface of the liquid ejection chip 111. For example, the protection member 116 protects the front surface of the liquid ejection chip 111 such that the print medium lifted or folded during printing does not come into contact with the front surface of the liquid ejection chip 111. The thickness of the protection member 116 is determined as appropriate depending on the stiffness of the print medium and the size of the openings of the protection member 116. For example, a stainless-steel plate with a thickness of 0.05 mm is used as the material of the protection member 116. Note that the thickness of the protection member 116 may be equal to or more than 0.02 mm and equal to or less than 0.2 mm.

A first end portion of the protection member 116 in the X direction protrudes in a fixed direction (+X direction) beyond a first end of the liquid ejection chip 111. A protruding amount of the protection member 116 in the +X direction with respect to the liquid ejection chip 111 is, for example, 0.2 mm. A second end portion opposite the first end of the liquid ejection chip 111 in the X direction protrudes in the opposite direction (-X direction) to the fixed direction beyond a second end opposite the first end portion of the protection member 116. The protruding amount of the liquid ejection chip 111 in the -X direction with respect to the protection member 116 is, for example, 0.3 mm. Part of the protection member 116 in the one liquid ejection device 110 in each pair of adjacent liquid ejection devices 110 overlaps the liquid ejection chip 111 in the other liquid ejection device 110. Specifically, the first end portion of the protection member 116 in the one liquid ejection device 110 overlaps the second end portion of the liquid ejection chip 111 in the other liquid ejection device 110 arranged side by side on the +X direction side of the one liquid ejection device 110. As described above, part of the one liquid ejection device 110 in each pair of adjacent liquid ejection devices 110 overlaps the other liquid ejection device 110 as viewed in a direction perpendicular to a plane of the common channel member 160 to which the multiple liquid ejection devices 110 are bonded.

In the present embodiment, the first end portion of the protection member 116 in the liquid ejection device 110 secondly bonded to the common channel member 160 overlaps the second end portion of the liquid ejection chip 111 in the liquid ejection device 110 firstly bonded to the common channel member 160. This establishes a state where the first end portion of the protection member 116 protruding in the fixed direction (+X direction) covers a gap between the adjacent liquid ejection devices 110. The fixed direction in which the first end portion of the protection member 116 protrudes is preferably the direction of the first arrow AR1 in FIGS. 4A and 4B, that is the direction in which the cleaning mechanism 30 cleans the face surface 119 of the protection member 116. Since the wiper 33 of the cleaning mechanism 30 is less likely to get caught on the protection member 116 in the case where the cleaning mechanism 30 cleans the face surface 119 of the protection member 116, peeling off of the protection member 116 from the liquid ejection chip 111 can be suppressed.

### Manufacturing Method of Liquid Ejection Head

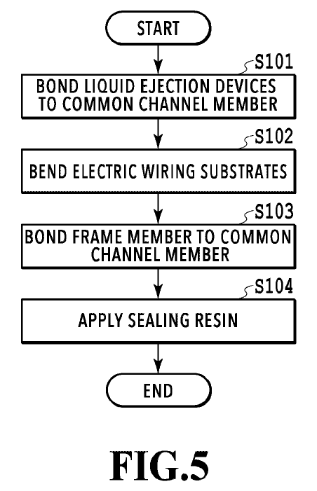

Next, a manufacturing method of the liquid ejection head 100 according to the first embodiment is schematically explained. FIG. 5 is a flowchart illustrating part of a manufacturing process of the liquid ejection head 100.

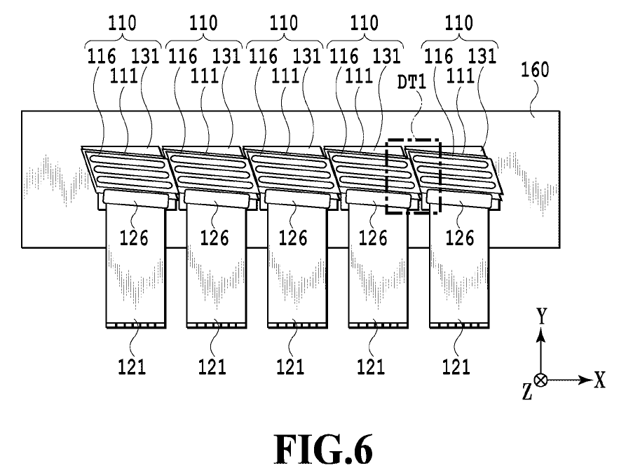

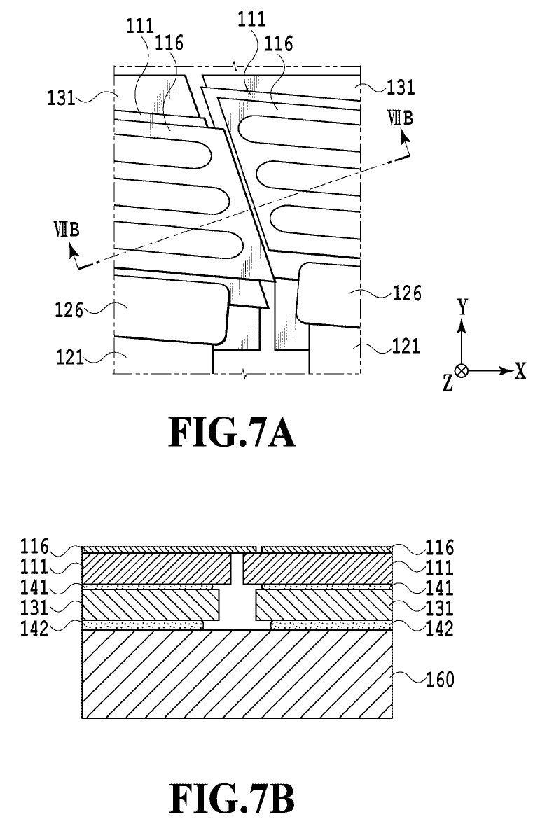

First, in step S101, the liquid ejection devices 110 are bonded to the common channel member 160. FIGS. 6-7B are schematic diagrams for explaining a process of bonding the liquid ejection devices 110 to the common channel member 160. FIG. 7A is an enlarged diagram of a portion surrounded by a frame DT1 in FIG. 6. FIG. 7B is a cross-sectional diagram along VIIB-VIIB in FIG. 7A. As illustrated in FIG. 6, in the process of bonding the liquid ejection devices 110, five liquid ejection devices 110 are bonded to the common channel member 160 in order from the side on which the protection members 116 protrude (+X direction side). Note that, prior to the bonding of the liquid ejection devices 110, a device adhesive agent 142 (see FIG. 7B) is applied to an opening in the common channel member 160 that is to communicate with the liquid ejection devices 110. The unevenness in the thickness of each of the liquid ejection devices 110, warping of the common channel member 160, and the like are absorbed with a squashing amount against the device adhesive agent 142, and the five liquid ejection devices 110 are bonded to be all at the same level. As illustrated in FIGS. 7A and 7B, the first end portion of the protection member 116 in each liquid ejection device 110 can thereby overlap the second end portion of the liquid ejection chip 111 in the liquid ejection device 110 arranged side by side on the side on which the protection member 116 protrudes with almost no gap.

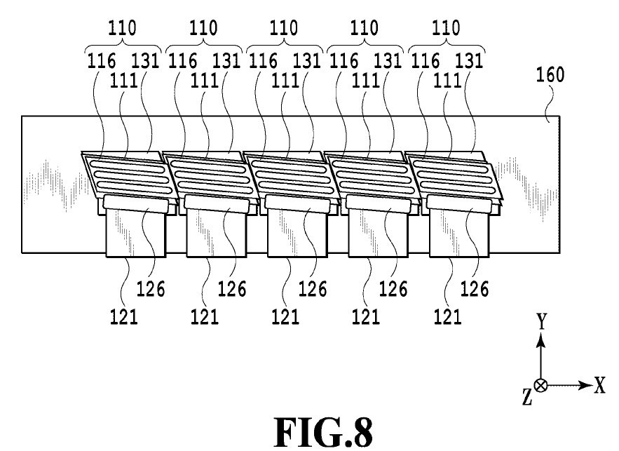

Next, in step S102 of FIG. 5, the electric wiring substrates 121 of the liquid ejection devices 110 are bent. FIG. 8 is a schematic diagram for explaining a process of bending the electric wiring substrates 121. As illustrated in FIG. 8, in the process of bending the electric wiring substrates 121, the electric wiring substrates 121 are bent along one lateral end portion of the common channel member 160 by using a jig (not illustrated) or the like. The other end portions of the electric wiring substrates 121 thereby extend from the lateral end portion of the common channel member 160 in the +Z direction.

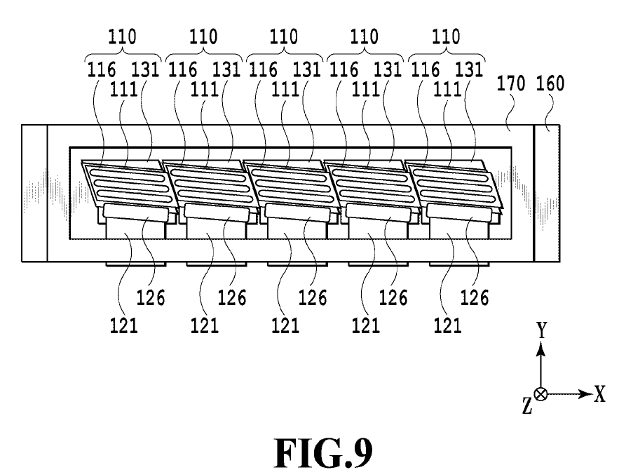

Next, in step S103 of FIG. 5, the frame member 170 is bonded to the common channel member 160. FIG. 9 is a schematic diagram for explaining a process of bonding the frame member 170 to the common channel member 160. As illustrated in FIG. 9, in the process of bonding the frame member 170, the frame member 170 is bonded to a portion near the outer periphery of the common channel member 160 by using an adhesive agent or the like. Intermediate portions of the electric wiring substrates 121 are thereby sandwiched between the frame member 170 and the common channel member 160.

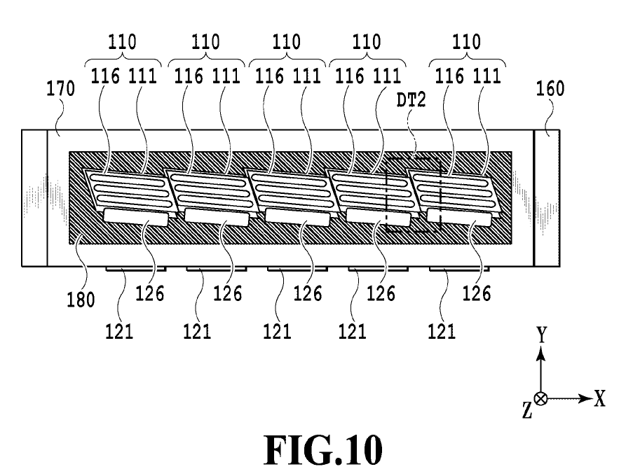

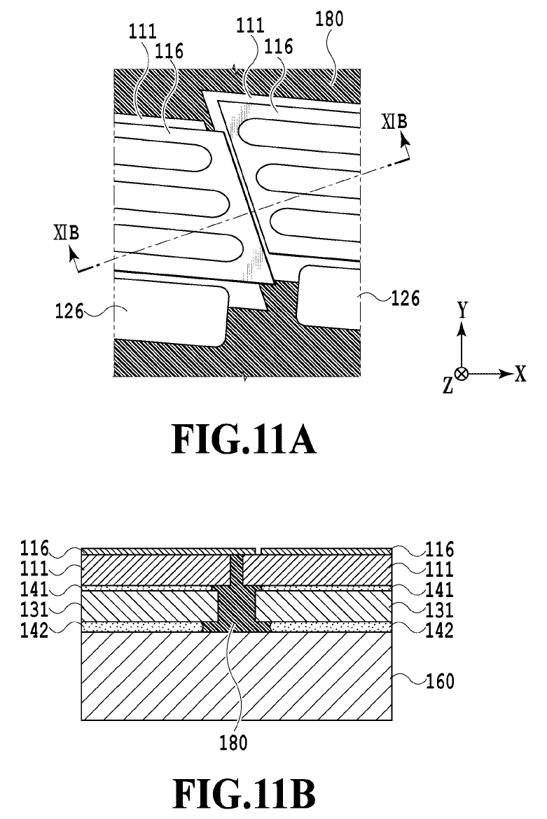

Then, in step S104 of FIG. 5, the sealing resin 180 is applied. FIGS. 10-11B are schematic diagrams for explaining a process of applying the sealing resin 180. FIG. 11A is an enlarged diagram of a portion surrounded by a frame DT2 in FIG. 10. FIG. 11B is a cross-sectional diagram along XIB-XIB of FIG. 11A. Note that, in FIGS. 10 and 11A, the sealing resin 180 is illustrated by being hatched to improve visibility of the diagrams. In FIGS. 10 and 11A, the hatching illustrated in the sealing resin 180 does not illustrate a cross section of the sealing resin 180.

As illustrated in FIG. 10, in the process of applying the sealing resin 180, the uncured sealing resin 180 with low viscosity is applied to portions of the common channel member 160 between the liquid ejection devices 110 (liquid ejection chips 111) and the frame member 170. As illustrated in FIGS. 11A and 11B, the uncured sealing resin 180 applied to the common channel member 160 flows into gaps between the adjacent liquid ejection devices 110, and fills the gaps between the adjacent liquid ejection devices 110. Moreover, the uncured sealing resin 180 flows over the electric wiring substrates 121 of the liquid ejection devices 110, and portions of the electric wiring substrates 121 surrounded by the frame member 170 are buried in the sealing resin 180. In the first embodiment, the gaps between the adjacent liquid ejection devices 110 are spaces surrounded by the protection members 116, the liquid ejection chips 111, the chip adhesive agent 141, the support members 131, and the device adhesive agent 142 (as well as the common channel member 160) that are adjacent to one another.

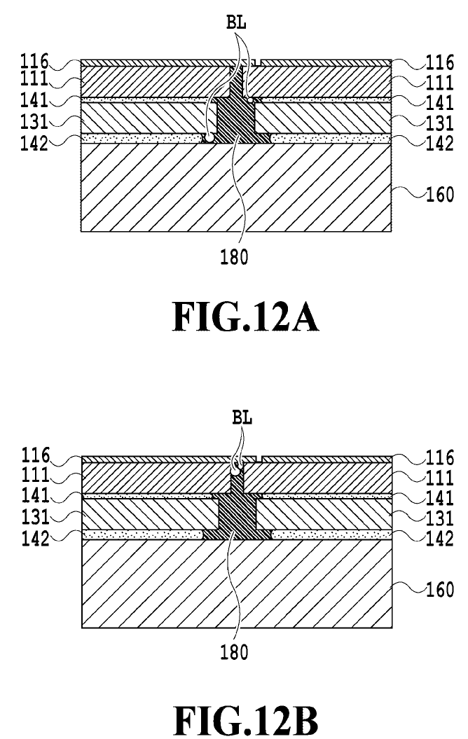

FIGS. 12A and 12B are schematic diagrams for explaining air bubbles BL trapped in the gap between the adjacent liquid ejection devices 110. FIG. 12A is a cross-sectional diagram illustrating a state where the air bubbles BL are trapped in the gap between the adjacent liquid ejection devices 110. FIG. 12B is a cross-sectional diagram illustrating a state where the air bubbles BL reach the back side of the protection member 116.

As illustrated in FIGS. 12A and 12B, in the case where the uncured sealing resin 180 flows into the gap between the adjacent liquid ejection devices 110, the air bubbles BL entrained in the sealing resin 180 are sometimes trapped in the gap between the adjacent liquid ejection devices 110. In a configuration in which the support members 131 and the chip adhesive agents 141 for converting a pitch of the liquid channels are present between the liquid ejection chips 111 and the common channel member 160, eaves and dead spaces tend to be formed on the end portion sides of the liquid ejection chips 111 or the support members 131. The air bubbles BL tend to be trapped in the eaves and the dead spaces formed on the end portion sides of the liquid ejection chips 111 or the support members 131. In the present embodiment, a two-component room temperature curing adhesive agent is used as the sealing resin 180. A curing time of about 24 hours is necessary for curing of the sealing resin 180 using the two-component room temperature curing adhesive agent. Accordingly, the air bubbles BL entrained in the sealing resin 180 float upward through the gap between the adjacent liquid ejection devices 110 by buoyancy, and stops at the back side of the protection members 116 protruding in the +X direction. Even in the case where the air bubbles BL burst, this configuration causes the sealing resin 180 scattered by bursting of the air bubbles BL to come into contact with the back side of the protection member 116, and the sealing resin 180 thus does not attach to the face surfaces 119 of the liquid ejection devices 110. Accordingly, it is possible to suppress the case where the sealing resin 180 scattered by the bursting of the air bubbles BL attaches to the face surfaces 119 of the liquid ejection devices 110 and the print quality decreases.

As explained above, according to the first embodiment, the print quality can be stabilized. In the present embodiment, part of the one liquid ejection device 110 in each pair of adjacent liquid ejection devices 110 overlaps the other liquid ejection device 110 as viewed in the direction (second direction) perpendicular to the plane of the common channel member 160 to which the multiple liquid ejection devices 110 are bonded. For example, part of the protection member 116 in the one liquid ejection device 110 (first liquid ejection device) in each pair of adjacent liquid ejection devices 110 overlaps the liquid ejection chip 111 in the other liquid ejection device 110 (second liquid ejection device). As described above, even in the case where the air bubbles BL burst, this configuration causes the sealing resin 180 scattered by the bursting of the air bubbles BL to come into contact with the back side of the protection member 116, and the sealing resin 180 thus does not attach to the face surfaces 119 of the liquid ejection devices 110. Accordingly, it is possible to suppress the case where the sealing resin 180 scattered by the bursting of the air bubbles BL attaches to the face surfaces 119 of the liquid ejection devices 110 and the print quality decreases. The print quality can be thereby stabilized.

In the above-mentioned first embodiment, in the liquid ejection device 110 located in an end portion on the +X direction side among the five liquid ejection devices 110, the first end portion of the protection member 116 in the X direction does not have to protrude beyond the first end of the liquid ejection chip 111. In the liquid ejection device 110 located in the end portion on the +X direction side, it is only necessary that the second end portion of the liquid ejection chip 111 in the X direction protrudes in the -X direction beyond the second end of the protection member 116. In the liquid ejection device 110 located in an end portion on the -X direction side among the five liquid ejection devices 110, the second end portion of the liquid ejection chip 111 does not have to protrude beyond the second end of the protection member 116. In the liquid ejection device 110 located in the end portion on the -X direction side, it is only necessary that the first end portion of the protection member 116 in the X direction protrudes in the +X direction beyond the first end of the liquid ejection chip 111.

In the above-mentioned first embodiment, the multiple ejection ports 113 of each liquid ejection chip 111 may be formed by a water-repellent material. The protection member 116 is stacked on and bonded to a surface of the water-repellent material forming the multiple ejection ports 113 of the liquid ejection chip 111, and this can suppress the case where the air bubbles BL stopped at the back side of the protection member 116 enters the front surface side of the liquid ejection chip 111.

Although the part of the protection member 116 in the one liquid ejection device 110 in each pair of adjacent liquid ejection devices 110 overlaps the liquid ejection chip 111 in the other liquid ejection device 110 in the above-mentioned first embodiment, the present disclosure is not limited to this. For example, the liquid ejection chip 111 may be a laminate in which multiple layers are stacked one on top of another. In this case, at least one layer of the liquid ejection chip 111 in the one liquid ejection device 110 in each pair of adjacent liquid ejection devices 110 may overlap at least one other layer of the liquid ejection chip 111 in the other liquid ejection device 110. Specifically, the at least one layer in the liquid ejection chip 111 may be a layer forming multiple ejection ports. A first end portion of the at least one layer (layer forming the multiple ejection ports) of the liquid ejection chip 111 in the X direction protrudes in a fixed direction (+X direction) beyond a first end of the at least one other layer of the liquid ejection chip 111. A second end portion opposite the first end of the at least one other layer of the liquid ejection chip 111 in the X direction protrudes in the opposite direction (-X direction) to the fixed direction beyond a second end opposite the first end portion of the at least one layer of the liquid ejection chip 111. Moreover, the first end portion of the at least one layer of the liquid ejection chip 111 in the one liquid ejection device 110 overlaps the second end portion of the at least one other layer of the liquid ejection chip 111 in the other liquid ejection device 110 arranged side by side on the +X direction side of the one liquid ejection device 110. Note that the layer forming the multiple ejection ports may be made of a water-repellent material. The protection member 116 may be provided or not provided on the surface of the liquid ejection chip 111.

### Second Embodiment

Next, a second embodiment of the liquid ejection head is explained. Since each of members in the second embodiment has a similar configuration to the corresponding member in the above-mentioned first embodiment, each of the members is explained while being denoted by the same sign as the corresponding member in the first embodiment described above. The liquid ejection head 100 according to the second embodiment is configured similarly to the liquid ejection head 100 according to the first embodiment except for the configuration of the liquid ejection devices 110. Explanation of portions of the second embodiment in common with the first embodiment is omitted as appropriate.

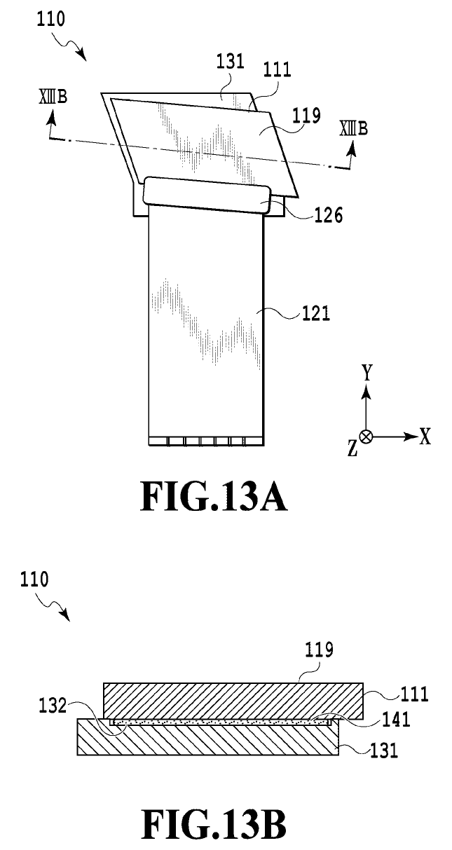

FIGS. 13A and 13B are schematic diagrams illustrating the liquid ejection device 110 of the second embodiment. FIG. 13A is a plan diagram of the liquid ejection device 110. FIG. 13B is a cross-sectional diagram along XIIIB-XIIIB in FIG. 13A. As illustrated in FIGS. 13A and 13B, the liquid ejection device 110 of the second embodiment includes the liquid ejection chip 111, the electric wiring substrate 121, and the support member 131.

The liquid ejection chip 111 in the second embodiment is formed similarly to the liquid ejection chip 111 in the first embodiment. The front surface of the liquid ejection chip 111 in the second embodiment is not covered with the protection member described in the first embodiment. The face surface 119 in which the three ejection port arrays are exposed is formed on the front surface of the liquid ejection chip 111. The liquid ejection chip 111 is bonded to the support member 131 by using the chip adhesive agent 141 (see FIG. 13B) at an interval large enough to cancel out a tolerance in the thickness direction of the liquid ejection chip 111.

The electric wiring substrate 121 in the second embodiment is formed similarly to the electric wiring substrate 121 in the first embodiment. A connecting portion (electric connection terminals) between the electric wiring substrate 121 and the liquid ejection chip 111 is insulated and protected by the sealing material 126 as in the first embodiment.

The support member 131 of the second embodiment is formed similarly to the support member 131 of the first embodiment. A recess portion 132 (see FIG. 13B) capable of receiving the chip adhesive agent 141 is formed in the support member 131 of the second embodiment. An adhesion surface and a contact surface with the liquid ejection chip 111 are thereby separately formed in the support member 131, and unevenness in the thickness of the liquid ejection chip 111 and the like can be thus absorbed with a squashing amount against the chip adhesive agent 141.

In the second embodiment, a first end portion of the liquid ejection chip 111 in the X direction protrudes in a fixed direction (+X direction) beyond a first end of the support member 131. A protruding amount of the liquid ejection chip 111 in the +X direction with respect to the support member 131 may be 0.2 mm. A second end portion opposite the first end of the support member 131 in the X direction protrudes in the opposite direction (-X direction) to the fixed direction beyond a second end opposite the first end portion of the liquid ejection chip 111. The protruding amount of the support member 131 in the -X direction with respect to the liquid ejection chip 111 may be 0.3 mm. Part of the liquid ejection chip 111 in the one liquid ejection device 110 in each pair of adjacent liquid ejection devices 110 overlaps the support member 131 in the other liquid ejection device 110. Specifically, the first end portion of the liquid ejection chip 111 in the one liquid ejection device 110 overlaps the second end portion of the support member 131 in the other liquid ejection device 110 arranged side by side on the +X direction side of the one liquid ejection device 110. As described above, part of the one liquid ejection device 110 in each pair of adjacent liquid ejection devices 110 overlaps the other liquid ejection device 110 as viewed in a direction perpendicular to a plane of the common channel member 160 to which the multiple liquid ejection devices 110 are bonded.

In the second embodiment, the first end portion of the liquid ejection chip 111 in the liquid ejection device 110 secondly bonded to the common channel member 160 overlaps the second end portion of the support member 131 in the liquid ejection device 110 firstly bonded to the common channel member 160. This establishes a state where the first end portion of the liquid ejection chip 111 protruding in the fixed direction (+X direction) covers a gap between the adjacent liquid ejection devices 110. The fixed direction in which the first end portion of the liquid ejection chip 111 protrudes is preferably the direction in which the cleaning mechanism 30 cleans the face surface 119 of the liquid ejection chip 111. Since the wiper 33 of the cleaning mechanism 30 is less likely to get caught on the liquid ejection chip 111 in the case where the cleaning mechanism 30 cleans the face surface 119 of the liquid ejection chip 111, peeling off of the liquid ejection chip 111 from the support member 131 can be suppressed.

### Manufacturing Method of Liquid Ejection Head

The liquid ejection head 100 according to the second embodiment is manufactured in a manufacturing method similar to that in the first embodiment. Accordingly, the manufacturing method of the liquid ejection head 100 according to the second embodiment is schematically explained by using the flowchart illustrated in FIG. 5.

First, in step S101, the liquid ejection devices 110 are bonded to the common channel member 160 as in the first embodiment. In the process of bonding the liquid ejection devices 110 of the second embodiment, five liquid ejection devices 110 are bonded to the common channel member 160 in order from the side on which the liquid ejection chips 111 protrude (+X direction side). The unevenness in the thickness of each of the liquid ejection devices 110, warping of the common channel member 160, and the like are absorbed with a squashing amount against the device adhesive agent 142, and the five liquid ejection devices 110 are bonded to be all at the same level. The first end portion of the liquid ejection chip 111 in each liquid ejection device 110 can thereby overlap the second end portion of the support member 131 in the liquid ejection device 110 arranged side by side on the side on which the liquid ejection chip 111 protrudes with almost no gap.

Next, in step S102, the electric wiring substrates 121 of the liquid ejection devices 110 are bent as in the first embodiment. The other end portions of the electric wiring substrates 121 thereby extend from the lateral end portion of the common channel member 160 in the +Z direction.

Next, in step S103, the frame member 170 is bonded to the common channel member 160 as in the first embodiment. Intermediate portions of the electric wiring substrates 121 are thereby sandwiched between the frame member 170 and the common channel member 160.

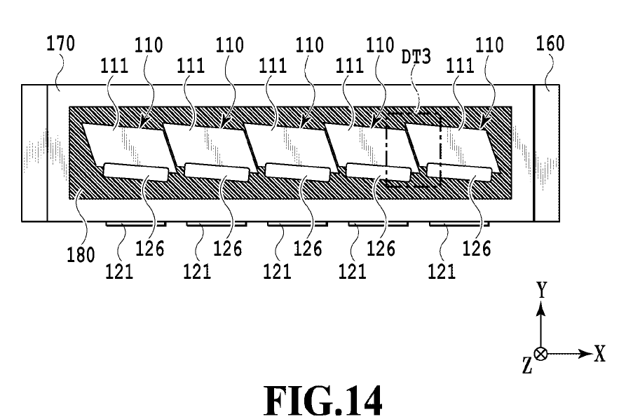

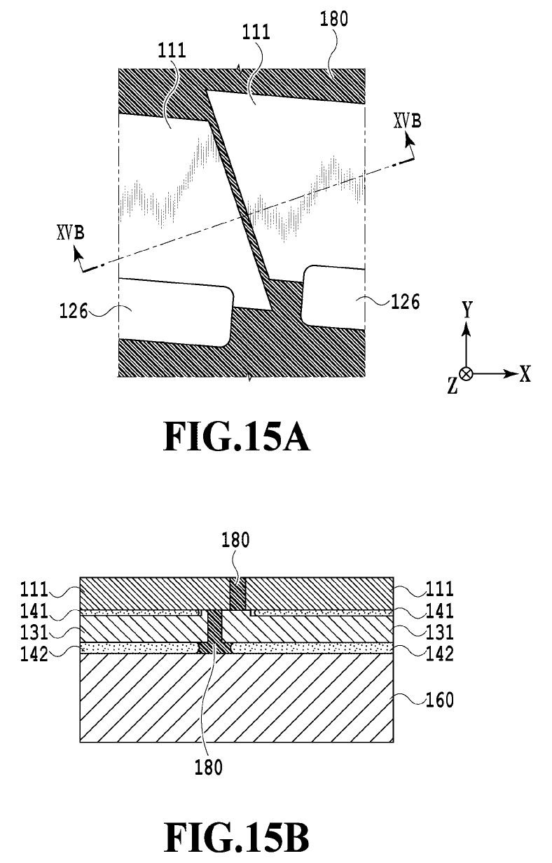

Then, in step S104, the sealing resin 180 is applied as in the first embodiment. FIGS. 14-15B are schematic diagrams for explaining a process of applying the sealing resin 180. FIG. 15A is an enlarged diagram of a portion surrounded by a frame DT3 of FIG. 14. FIG. 15B is a cross-sectional diagram along XVB-XVB of FIG. 15A. Note that, in FIGS. 14 and 15A, the sealing resin 180 is illustrated by being hatched to improve visibility of the diagrams. In FIGS. 14 and 15A, the hatching illustrated in the sealing resin 180 does not illustrate a cross section of the sealing resin 180.

As illustrated in FIG. 14, in the process of applying the sealing resin 180, the uncured sealing resin 180 with low viscosity is applied to portions of the common channel member 160 between the liquid ejection devices 110 (liquid ejection chips 111) and the frame member 170. As illustrated in FIGS. 15A and 15B, the uncured sealing resin 180 applied to the common channel member 160 flows into gaps between the adjacent liquid ejection devices 110, and fills the gaps between the adjacent liquid ejection devices 110. Moreover, the uncured sealing resin 180 flows over the electric wiring substrates 121 of the liquid ejection devices 110, and portions of the electric wiring substrates 121 surrounded by the frame member 170 are buried in the sealing resin 180. In the second embodiment, the gaps between the adjacent liquid ejection devices 110 are spaces surrounded by the liquid ejection chips 111, the chip adhesive agent 141, the support members 131, and the device adhesive agent 142 (as well as the common channel member 160) that are adjacent to one another.

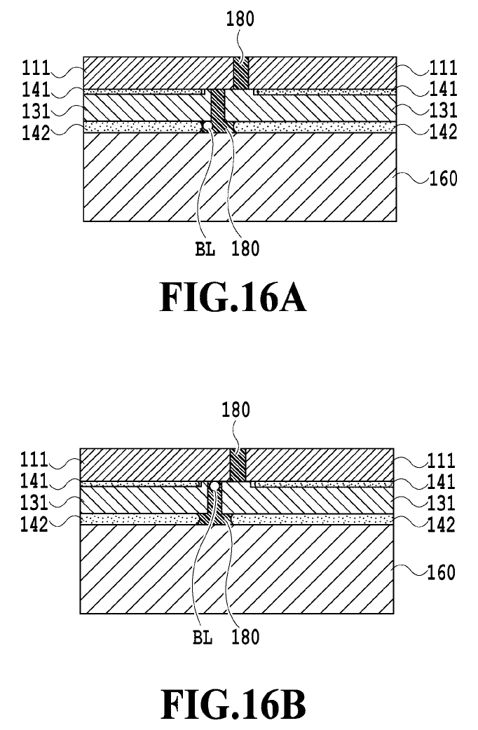

FIGS. 16A and 16B are schematic diagrams for explaining air bubbles BL trapped in the gap between the adjacent liquid ejection devices 110. FIG. 16A is a cross-sectional diagram illustrating a state where the air bubbles BL are trapped in the gap between the adjacent liquid ejection devices 110. FIG. 16B is a cross-sectional diagram illustrating a state where the air bubbles BL reach the back side of the liquid ejection chip 111.

As illustrated in FIGS. 16A and 16B, in the case where the uncured sealing resin 180 flows into the gap between the adjacent liquid ejection devices 110, the air bubbles BL entrained in the sealing resin 180 are sometimes trapped in the gap between the adjacent liquid ejection devices 110. The air bubbles BL entrained in the sealing resin 180 float upward through the gap between the adjacent liquid ejection devices 110 by buoyancy, and stops at the back side of the liquid ejection chip 111 protruding in the +X direction. Even in the case where the air bubbles BL burst, this configuration causes the sealing resin 180 scattered by bursting of the air bubbles BL to come into contact with the back side of the liquid ejection chip 111, and the sealing resin 180 thus does not attach to the face surfaces 119 of the liquid ejection devices 110. Accordingly, it is possible to suppress the case where the sealing resin 180 scattered by the bursting of the air bubbles BL attaches to the face surfaces 119 of the liquid ejection devices 110 and the print quality decreases. Note that the uncured sealing resin 180 applied to the common channel member 160 also flows into gaps between the adjacent liquid ejection chips 111. However, since there are no eaves, the possibility that the air bubbles BL entrained in the sealing resin 180 are trapped in the gaps between the adjacent liquid ejection chips 111 is low.

As explained above, according to the second embodiment, it is possible to suppress a decrease of the print quality and stabilize the print quality as in the first embodiment. Moreover, part of the liquid ejection chip 111 in one liquid ejection device 110 (first liquid ejection device) in each pair of adjacent liquid ejection devices 110 overlaps the support member 131 in the other liquid ejection device 110 (second liquid ejection device). As described above, even in the case where the air bubbles BL burst, this configuration causes the sealing resin 180 scattered by the bursting of the air bubbles BL to come into contact with the back side of the liquid ejection chip 111, and the sealing resin 180 thus does not attach to the face surfaces 119 of the liquid ejection devices 110.

In the above-mentioned second embodiment, in the liquid ejection device 110 located in an end portion on the +X direction side among the five liquid ejection devices 110, the first end portion of the liquid ejection chip 111 does not have to protrude beyond the first end of the support member 131. In the liquid ejection device 110 located in the end portion on the +X direction side, it is only necessary that the second end portion of the support member 131 in the X direction protrudes in the -X direction beyond the second end of the liquid ejection chip 111. In the liquid ejection device 110 located in an end portion on the -X direction side among the five liquid ejection devices 110, the second end portion of the support member 131 does not have to protrude beyond the second end of the liquid ejection chip 111. In the liquid ejection device 110 located in the end portion on the -X direction side, it is only necessary that the first end portion of the liquid ejection chip 111 in the X direction protrudes in the +X direction beyond the first end of the support member 131.

### Third Embodiment

Next, a third embodiment of the liquid ejection head is explained. Since each of members in the third embodiment has a similar configuration to the corresponding member in the above-mentioned first embodiment, each of the members is explained while being denoted by the same sign as the corresponding member in the above-mentioned first embodiment. The liquid ejection head 100 according to the third embodiment is configured similarly to the liquid ejection head 100 according to the first embodiment except for the shape of the protection member 116. Explanation of portions of the third embodiment in common with the first embodiment is omitted as appropriate.

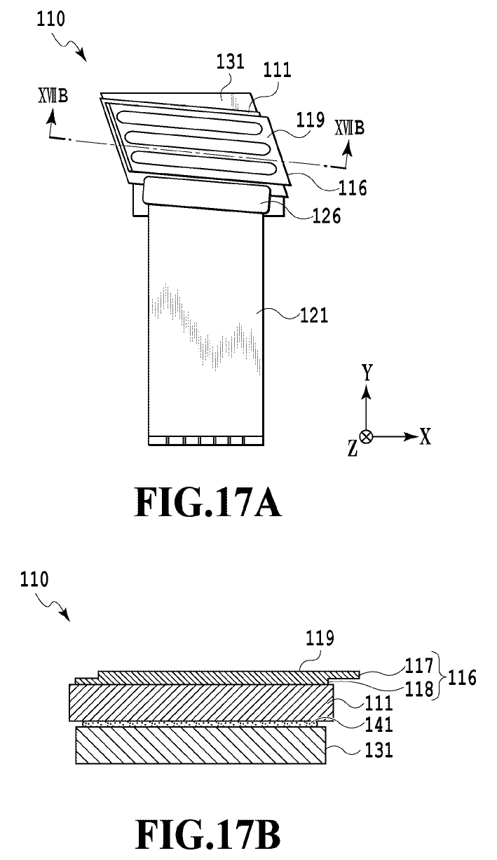

FIGS. 17A and 17B are schematic diagrams illustrating the liquid ejection device 110 of the third embodiment. FIG. 17A is a plan diagram of the liquid ejection device 110. FIG. 17B is a cross-sectional diagram along XVIIB-XVIIB of FIG. 17A. As illustrated in FIGS. 17A and 17B, the liquid ejection device 110 of the third embodiment includes the liquid ejection chip 111, the protection member 116, the electric wiring substrate 121, and the support member 131. The liquid ejection chip 111, the electric wiring substrate 121, and the support member 131 of the third embodiment are formed similarly to the liquid ejection chip 111, the electric wiring substrate 121, and the support member 131 of the first embodiment.

The protection member 116 in the third embodiment is formed in a parallelogram plate shape like the protection member 116 in the first embodiment. A portion of the protection member 116 where the face surface 119 is formed in the thickness direction (Z direction) of the protection member 116 is referred to as a front side part 117 of the protection member 116. A portion of the protection member 116 on the opposite side to the face surface 119 is referred to as a back side part 118 of the protection member 116.

In the third embodiment, a first end portion of the front side part 117 of the protection member 116 in the X direction protrudes in a fixed direction (+X direction) beyond a first end of the back side part 118 of the protection member 116. A protruding amount of the front side part 117 in the +X direction with respect to the back side part 118 of the protection member 116 may be 0.2 mm. A second end portion opposite the first end of the back side part 118 of the protection member 116 in the X direction protrudes in the opposite direction (-X direction) to the fixed direction beyond a second end opposite the first end portion of the front side part 117 of the protection member 116. The protruding amount of the back side part 118 in the -X direction with respect to the front side part 117 of the protection member 116 may be 0.3 mm. Part of the front side part 117 of the protection member 116 in one liquid ejection device 110 in each pair of adjacent liquid ejection devices 110 overlaps the back side part 118 of the protection member 116 in the other liquid ejection device 110. Specifically, the first end portion of the front side part 117 of the protection member 116 in the one liquid ejection device 110 overlaps the second end portion of the back side part 118 of the protection member 116 in the other liquid ejection device 110 arranged side by side on the +X direction side of the one liquid ejection device 110. As described above, part of one liquid ejection device 110 in each pair of adjacent liquid ejection devices 110 overlaps the other liquid ejection device 110 as viewed in a direction perpendicular to a plane of the common channel member 160 to which the multiple liquid ejection devices 110 are bonded.

In the third embodiment, the first end portion of the front side part 117 of the protection member 116 in the liquid ejection device 110 secondly bonded to the common channel member 160 overlaps the second end portion of the back side part 118 of the protection member 116 in the liquid ejection device 110 firstly bonded to the common channel member 160. This establishes a state where the first end portion of the front side part 117 of the protection member 116 protruding in the fixed direction (+X direction) covers a gap between the adjacent liquid ejection devices 110. The fixed direction in which the first end portion of the front side part 117 of the protection member 116 protrudes is preferably the direction in which the cleaning mechanism 30 cleans the face surface 119 of the protection member 116. Since the wiper 33 of the cleaning mechanism 30 is less likely to get caught on the protection member 116 in the case where the cleaning mechanism 30 cleans the face surface 119 of the protection member 116, peeling off of the protection member 116 from the liquid ejection chip 111 can be suppressed.

Note that the protection member 116 of the third embodiment may be formed of one plate material or formed by attaching two plate members of different materials to each other. In the case where the protection member 116 is formed by attaching the two plate materials to each other, the protection member 116 may be formed by attaching a plate member forming the front side part 117 of the protection member 116 and a plate member forming the back side part 118 of the protection member 116 to each other. In this case, the plate member forming the front side part 117 of the protection member 116 may have a higher water-repellency than the plate member forming the back side part 118 of the protection member 116.

### Manufacturing Method of Liquid Ejection Head

The liquid ejection head 100 according to the third embodiment is manufactured in a manufacturing method similar to that in the first embodiment. Accordingly, the manufacturing method of the liquid ejection head 100 according to the third embodiment is schematically explained by using the flowchart illustrated in FIG. 5.

First, in step S101, the liquid ejection devices 110 are bonded to the common channel member 160 as in the first embodiment. In the process of bonding the liquid ejection devices 110 in the third embodiment, five liquid ejection devices 110 are bonded to the common channel member 160 in order from the side on which the front side parts 117 of the protection members 116 protrude (+X direction side). The unevenness in the thickness of each of the liquid ejection devices 110, warping of the common channel member 160, and the like are absorbed with a squashing amount against the device adhesive agent 142, and the five liquid ejection devices 110 are bonded to be all at the same level. The first end portion of the front side part 117 of the protection member 116 in each liquid ejection device 110 can thereby overlap the second end portion of the back side part 118 of the protection member 116 in the liquid ejection device 110 arranged side by side on the side on which the front side part 117 protrudes with almost no gap.

Next, in step S102, the electric wiring substrates 121 of the liquid ejection devices 110 are bent as in the first embodiment. The other end portions of the electric wiring substrates 121 thereby extend from the lateral end portion of the common channel member 160 in the +Z direction.

Next, in step S103, the frame member 170 is bonded to the common channel member 160 as in the first embodiment. Intermediate portions of the electric wiring substrates 121 are thereby sandwiched between the frame member 170 and the common channel member 160.

Then, in step S104, the sealing resin 180 is applied as in the first embodiment. In the process of applying the sealing resin 180, the uncured sealing resin 180 with low viscosity is applied to portions of the common channel member 160 between the liquid ejection devices 110 (liquid ejection chips 111) and the frame member 170. The uncured sealing resin 180 applied to the common channel member 160 flows into gaps between the adjacent liquid ejection devices 110, and fills the gaps between the adjacent liquid ejection devices 110. Moreover, the uncured sealing resin 180 flows over the electric wiring substrates 121 of the liquid ejection devices 110, and portions of the electric wiring substrates 121 surrounded by the frame member 170 are buried in the sealing resin 180. In the third embodiment, the gaps between the adjacent liquid ejection devices 110 are spaces surrounded by the protection members 116, the liquid ejection chips 111, the chip adhesive agent 141, the support members 131, and the device adhesive agent 142 (as well as the common channel member 160) that are adjacent to one another.

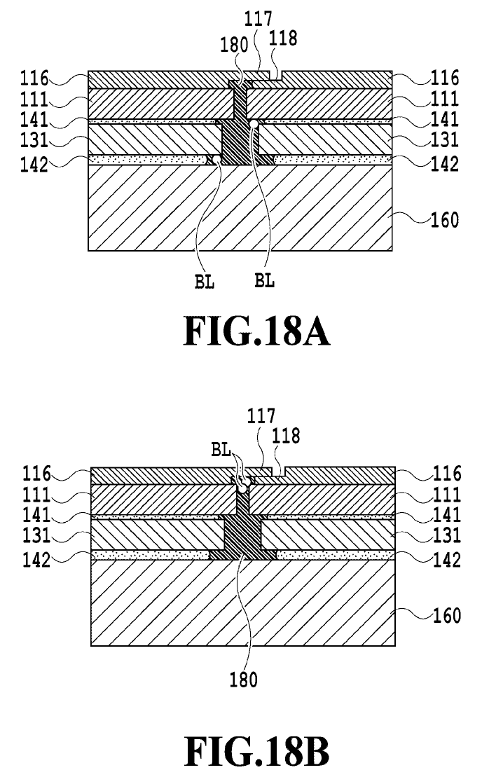

FIGS. 18A and 18B are schematic diagrams for explaining air bubbles BL trapped in the gap between the adjacent liquid ejection devices 110. FIG. 18A is a cross-sectional diagram illustrating a state where the air bubbles BL are trapped in the gap between the adjacent liquid ejection devices 110. FIG. 18B is a cross-sectional diagram illustrating a state where the air bubbles BL reach the back side of the protection member 116.

As illustrated in FIGS. 18A and 18B, in the case where the uncured sealing resin 180 flows into the gap between the adjacent liquid ejection devices 110, the air bubbles BL entrained in the sealing resin 180 are sometimes trapped in the gap between the adjacent liquid ejection devices 110. The air bubbles BL entrained in the sealing resin 180 float upward through the gap between the adjacent liquid ejection devices 110 by buoyancy, and stops at the back side of the front side part 117 of the protection member 116 protruding in the +X direction. Even in the case where the air bubbles BL burst, this configuration causes the sealing resin 180 scattered by bursting of the air bubbles BL to come into contact with the back side of the front side part 117 of the protection member 116, and the sealing resin 180 thus does not attach to the face surfaces 119 of the liquid ejection devices 110. Accordingly, it is possible to suppress the case where the sealing resin 180 scattered by the bursting of the air bubbles BL attaches to the face surfaces 119 of the liquid ejection devices 110 and the print quality decreases.

As explained above, according to the third embodiment, it is possible to suppress a decrease of the print quality and stabilize the print quality as in the first embodiment. Moreover, part of the front side part 117 of the protection member 116 in one liquid ejection device 110 (first liquid ejection device) in each pair of adjacent liquid ejection devices 110 overlaps the back side part 118 of the protection member 116 in the other liquid ejection device 110 (second liquid ejection device). As described above, even in the case where the air bubbles BL burst, this configuration causes the sealing resin 180 scattered by the bursting of the air bubbles BL to come into contact with the back side of the front side part 117 of the protection member 116, and the sealing resin 180 thus does not attach to the face surfaces 119 of the liquid ejection devices 110.

In the above-mentioned third embodiment, in the liquid ejection device 110 located in an end portion on the +X direction side among the five liquid ejection devices 110, the first end portion of the front side part 117 of the protection member 116 does not have to protrude beyond the first end of the back side part 118 of the protection member 116. In the liquid ejection device 110 located in the end portion on the +X direction side, it is only necessary that the second end portion of the back side part 118 of the protection member 116 in the X direction protrudes in the -X direction beyond the second end of the front side part 117 of the protection member 116. In the liquid ejection device 110 located in an end portion on the -X direction side among the five liquid ejection devices 110, the second end portion of the back side part 118 of the protection member 116 does not have to protrude beyond the second end of the front side part 117 of the protection member 116. In the liquid ejection device 110 located in the end portion on the -X direction side, it is only necessary that the first end portion of the front side part 117 of the protection member 116 in the X direction protrudes in the +X direction beyond the first end of the back side part 118 of the protection member 116.

Although the liquid ejection head 100 includes five liquid ejection devices 110 in each of the above-mentioned embodiments, the present disclosure is not limited to this. For example, the liquid ejection head 100 may include four liquid ejection devices 110, three liquid ejection devices 110, or two liquid ejection devices 110. Alternatively, the liquid ejection head 100 may include six or more liquid ejection devices 110.

Although the liquid ejection head 100 is a so-called line-type liquid ejection head in each of the above-mentioned embodiments, the present disclosure is not limited to this. For example, the liquid ejection head may be a so-called serial liquid ejection head that performs printing while performing scanning in a direction intersecting (for example, orthogonal to) an array direction of the ejection ports. The technique of the present disclosure can be applied also to the serial liquid ejection head as described above.

Although the inks are used as the liquid in each of the above-mentioned embodiments, the liquid to which the technique of the present disclosure can be applied is not limited to the inks. For example, treatment liquids used to improve fixability of the inks in the print medium, used to reduce gloss unevenness, used to improve scratch resistance, and the like may be used as the liquid.

Although the electrothermal transducing elements are used as energy generating elements that apply energy necessary for ejection to the inks (liquid) in each of the above-mentioned embodiments, the present disclosure is not limited to this. For example, piezoelectric elements may be used as the energy generating elements.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, the print quality can be stabilized.

This application claims the benefit of Japanese Patent Application No. 2025-076198, filed May 1, 2025, which is hereby incorporated by reference herein in its entirety.

What is claimed is:

1. A liquid ejection head comprising:
a plurality of liquid ejection devices aligned in a first direction and configured to eject liquid;
a common channel member bonded to the plurality of liquid ejection devices; and
a sealing resin provided in a gap in the first direction between a first liquid ejection device and a second liquid ejection device that are the liquid ejection devices adjacent to each other among the plurality of liquid ejection devices, and
part of the first liquid ejection device overlaps the second liquid ejection device as viewed in a second direction perpendicular to a plane of the common channel member to which the plurality of liquid ejection devices are bonded.

2. The liquid ejection head according to claim 1, wherein
each of the liquid ejection devices includes
a liquid ejection chip having a plurality of ejection ports configured to eject the liquid, and
a protection member provided to be stacked on the liquid ejection chip and having a face surface including an opening through which the plurality of ejection ports are exposed, and
part of the protection member in the first liquid ejection device overlaps the liquid ejection chip in the second liquid ejection device as viewed in the second direction.

3. The liquid ejection head according to claim 2, wherein
the second liquid ejection device is arranged side by side on the first direction side of the first liquid ejection device,
in the first liquid ejection device, a first end portion of the protection member in the first direction protrudes in the first direction beyond a first end of the liquid ejection chip,
in the second liquid ejection device, a second end portion opposite the first end of the liquid ejection chip in the first direction protrudes in an opposite direction to the first direction beyond a second end opposite the first end portion of the protection member, and
the first end portion of the protection member in the first liquid ejection device overlaps the second end portion of the liquid ejection chip in the second liquid ejection device as viewed in the second direction.

4. The liquid ejection head according to claim 1, wherein
each of the liquid ejection devices includes
a liquid ejection chip having a plurality of ejection ports configured to eject the liquid, and
a protection member provided to be stacked on the liquid ejection chip and having a face surface including an opening through which the plurality of ejection ports are exposed, and
the face surface is formed in a front side part of the protection member, and
part of the front side part of the protection member in the first liquid ejection device overlaps a back side part of the protection member in the second liquid ejection device as viewed in the second direction.

5. The liquid ejection head according to claim 4, wherein
the second liquid ejection device is arranged side by side on the first direction side of the first liquid ejection device,
in the first liquid ejection device, a first end portion of the front side part of the protection member in the first direction protrudes in the first direction beyond a first end of the back side part of the protection member,
in the second liquid ejection device, a second end portion opposite the first end of the back side part of the protection member in the first direction protrudes in an opposite direction to the first direction beyond a second end opposite the first end portion of the front side part of the protection member, and
the first end portion of the front side part of the protection member in the first liquid ejection device overlaps the second end portion of the back side part of the protection member in the second liquid ejection device as viewed in the second direction.

6. The liquid ejection head according to claim 2, wherein each of the liquid ejection devices includes
an electric wiring substrate electrically connected to the liquid ejection chip, and
a support member supporting the liquid ejection chip and the electric wiring substrate and bonded to the common channel member.

7. The liquid ejection head according to claim 2, wherein
the liquid ejection head is a liquid ejection head used in a liquid ejection apparatus configured to eject the liquid, and
the first direction is a direction in which a cleaning mechanism of the liquid ejection apparatus cleans the face surface.

8. The liquid ejection head according to claim 1, wherein
each of the liquid ejection devices includes
a liquid ejection chip having a plurality of ejection ports configured to eject the liquid, and
a support member supporting the liquid ejection chip and bonded to the common channel member, and
part of the liquid ejection chip in the first liquid ejection device overlaps the support member in the second liquid ejection device as viewed in the second direction.

9. The liquid ejection head according to claim 8, wherein
the second liquid ejection device is arranged side by side on the first direction side of the first liquid ejection device,
in the first liquid ejection device, a first end portion of the liquid ejection chip in the first direction protrudes in the first direction beyond a first end of the support member,
in the second liquid ejection device, a second end portion opposite the first end of the support member in the first direction protrudes in an opposite direction to the first direction beyond a second end opposite the first end portion of the liquid ejection chip, and
the first end portion of the liquid ejection chip in the first liquid ejection device overlaps the second end portion of the support member in the second liquid ejection device as viewed in the second direction.

10. The liquid ejection head according to claim 8, wherein
each of the liquid ejection devices includes an electric wiring substrate electrically connected to the liquid ejection chip, and
the support member supports the liquid ejection chip and the electric wiring substrate, and is bonded to the common channel member.

11. The liquid ejection head according to claim 1, wherein
each of the liquid ejection devices includes a liquid ejection chip having a plurality of ejection ports configured to eject the liquid,
the liquid ejection chip is a laminate in which a plurality of layers are stacked one on top of another, and
at least one layer of the liquid ejection chip in the first liquid ejection device overlaps at least one other layer of the liquid ejection chip in the second liquid ejection device as viewed in the second direction.

12. The liquid ejection head according to claim 11, wherein
the second liquid ejection device is arranged side by side on the first direction side of the first liquid ejection device,
in the first liquid ejection device, a first end portion of the at least one layer of the liquid ejection chip in the first direction protrudes in the first direction beyond a first end of the at least one other layer of the liquid ejection chip,
in the second liquid ejection device, a second end portion opposite the first end of the at least one other layer of the liquid ejection chip in the first direction protrudes in an opposite direction to the first direction beyond a second end opposite the first end portion of the at least one layer of the liquid ejection chip, and
the first end portion of the at least one layer of the liquid ejection chip in the first liquid ejection device overlaps the second end portion of the at least one other layer of the liquid ejection chip in the second liquid ejection device as viewed in the second direction.

13. The liquid ejection head according to claim 11, wherein the at least one layer of the liquid ejection chip is a layer having the plurality of ejection ports.

14. The liquid ejection head according to claim 11, wherein each of the liquid ejection devices includes
an electric wiring substrate electrically connected to the liquid ejection chip, and
a support member supporting the liquid ejection chip and the electric wiring substrate and bonded to the common channel member.

15. The liquid ejection head according to claim 8, wherein
the liquid ejection head is a liquid ejection head used in a liquid ejection apparatus configured to eject the liquid, and
the first direction is a direction in which a cleaning mechanism of the liquid ejection apparatus cleans a face surface on which the plurality of ejection ports are formed in the liquid ejection chip.

16. The liquid ejection head according to claim 1, wherein the sealing resin is further provided in peripheries of the first liquid ejection device and the second liquid ejection device.

17. The liquid ejection head according to claim 2, wherein a planar shape of the liquid ejection chip is a parallelogram.
